(19) United States
(12) Patent Application Publication
(10) Pub. No.: US 2002/0087415 A1
(43) Pub. Date: Jul. 4, 2002

(54) Method and system for on-line shopping utlizing personalized shopping list and electronic network

(76) Inventors: Joseph T. Allen, Independence, MO (US); Kenneth P. Murphy, St. Charles, MO (US); William P. Rice, New Cambria, MO (US); Lane R. Schartz, Olathe, KS (US); William M. Shaffer, Quincy, IL (US); Phillip A. Skeed, Lee's Summit, MO (US)

Correspondence Address: Chase & Yakimo, L.C., Suite 130, 4400 College Boulevard, Overland Park, KS, 66211, US

(21) Appl. No.: 09/753,864

(22) Filed: Jan. 3, 2001

(51) Int. Cl. G06G 1/12; G06F 17/60

(52) U.S. Cl. 705/21; 705/26

(57) ABSTRACT

A computer-implemented method and system for purchasing products and services by customers utilizes a product scanner or other input device to collect information directly from the product or description of the service the customer wishes to purchase. The scanned information is transferred to an Internet access device for transmittal to a web site for processing and organization to present a shopping list to the customer. The shopping list may be automatically or selectively processed to order the selected products from member vendors for shipment directly to the customer.

### BACKGROUND OF THE INVENTION

This invention relates to an interactive, computer-implemented method and apparatus for information presentation and management in an online environment, and, in particular, to a data collection and online ordering system, which allows users to scan product or service information which is transferred to a remote computer system over an electronic network to purchase the products or services from retailers, wholesalers or distributors for delivery to the user. Online service systems which allow users to purchase goods and services from a variety of different merchants or service providers over a distributed computer network such as the Internet are known. The Internet is a global network connecting millions of computers. Access to the Internet is provided by Internet service providers (ISP), also called Internet access providers (IAP). One popular part to the Internet is the World Wide Web which consists of a collection of interlinked electronic documents hosted on web site servers that work together using a specific Internet protocol called hypertext transfer protocol (HTTP). HTTP defines how messages are formatted and transmitted and what actions web servers and web browsers installed on user computers should take in response to various commands. These documents are created using a software language, called hypertext markup language (HTML), which defines the structure and layout of a web document.

HTML documents are generally static electronic documents. In order to manage user input, HTML documents may include links to executable programs such as Java applets, or control codes such as JavaScript may be integrated into the HTML document using special tags. Java is a programming language similar to C++ that is used to create stand alone executable application programs called applets. JavaScript is a scripting language that is interpreted by the web browser software running on the user's computer.

A user may access the Internet using a personal computer equipped with a modem or other network access hardware. Interface software is installed in the personal computer so that when the user wishes to access the Internet, the modem is automatically instructed to dial the telephone number associated with the user's ISP. The user can then browse the Internet to access online information using commercially available browser software such as Netscape Navigator or Microsoft Internet Explorer. This online information is typically organized by web sites and web pages within a web site. Every web page is identified using a unique electronic address or uniform resource locator (URL). Generally, a web page is an electronic document, written in HTML, JavaScript and/or Java, which organizes the presentation of text, graphical images, audio, video, and links to other web pages into a desired display. An interactive web page manages user input in response to events such as a mouse click or keyboard entry to a web page from the user's personal computer. Web sites are accessed through a wide variety of commercial ISPs such as America Online, CompuServe or Microsoft Network.

In an online commerce environment, a user can visit a merchant's electronic store or web site and interactively view merchandise or descriptions of services on the user's personal computer. A user may purchase goods or services from these electronic stores by selecting the desired good or service, providing a shipping or mailing address, and billing information to the online merchant. This type of system is similar to a mail-order catalog system, where the customer chooses the merchandise, fills out an order form, and mails it to the company for processing.

One problem with this online commerce environment is that the user often times has trouble locating a particular product of interest. Additionally, when the product is found, the user isn't sure that this product is exactly the same as the product he or she is interested in purchasing. If the user has a shopping list of items, he or she is forced to visit multiple web sites, fill out demographic information, billing information and shipping information for each web site from which the user wishes to purchase the product. Also, the user then has the added burden of tracking each individual order.

### SUMMARY OF THE INVENTION

It is therefore a primary object of the present invention to provide a method and apparatus for simple and efficient use of the Internet for selection and purchase of a product or service.

Another important object of the present invention is to provide a method and apparatus, as aforesaid, which scans information from the desired product or service description and automatically transmits this information to a web site for automatic purchase.

Yet another important object of the present invention is to provide a method and apparatus, as aforesaid, for purchasing products or services from distinct vendors from a single location.

Still another important object of the present invention is to provide a method and apparatus, as aforesaid, which presents customized information to a user for comparison shopping, selection, and purchase.

These and other objects of the invention are achieved by a software program which runs in the background on a personal computer which intermittently polls a bar code scanner to determine if any bar codes are present in the scanner. When new bar codes are present, the software stores the bar code on the PC hard drive, clears the scanner's memory and automatically transmits the bar codes to a web based host site. The transmission includes a user identifier. The PC software verifies the success transmission of each bar code scanned. In the event the transmission to the web based host site is unsuccessful, the PC software retains the bar codes not transmitted until such time as a successful transmission may be made. If a successful transmission is made, the successfully transmitted bar code is removed from the PC's hard drive so that a duplicate transmission will not be made. The PC software automatically transmits bar codes from the scanner to the web based host computer by reading the scanner, storing all bar codes from the scanner on the PC, automatically establishing communication with the web based host site, authorizing the transmittees authority to transmit and store bar codes at the web based host site, transmits and receives acknowledgement of each transaction, and removes successfully transmitted bar codes. In the event of an unsuccessful transaction, the PC software notifies the user of a transmission error and allows the user to restart the transmission process.

The web site software receives bar code and user identification codes from the PC software and returns a response code to the PC software indicating a successful or unsuccessful transaction. Upon receipt of a valid bar code from a valid transmittee, the web software stores the bar code and user ID on the web site and then awaits the next transaction. Upon receipt of a bar code from an invalid user, the web site software rejects the transaction and informs the PC software of the rejection.

The web site software organizes the items received and provides pricing and availability details to the user on the web site. Periodically and automatically at the user's option, the web site process orders the items by faxing an order form to the vendor associated with a product or orders the product by e-mail. The products are then delivered to the user.

### BRIEF DESCRIPTION OF THE DRAWINGS

FIG. 1 illustrates a hand held bar code scanner scanning a UPC bar code on a product.

FIG. 2 illustrates a scanner interfaced with a computer.

FIG. 3 is a software flowchart for the Quixscan PC program.

FIG. 4 is a continuation of the flowchart of FIG. 3, and illustrates the interface to the Quixscan web site software.

FIG. 5 is a software flowchart illustrating the web site software.

FIG. 6 is a flowchart illustrating processing related to the sign in page and the user shopping home page of the Quixscan web site.

FIG. 7 is a flowchart illustrating the daily fax (or facts?) transmission software of the Quixscan web site software.

FIG. 8 is a software flowchart illustrating the daily electronic order transmission software of the Quixscan web site software.

### DESCRIPTION OF THE PREFERRED EMBODIMENT

Turning more particularly to the drawings, FIG. 1 illustrates a Personal Scanning Device (PSD) or bar code scanner 10 for scanning the UPC bar code 14 commonly found on consumer products such as a can of vegetables 12. UPC symbol 14 is used on items in the retail end food industry. Bar code 14 is a method of using a combination of bars and spaces of varying widths to end code numbers and letters which may easily be read by scanner 10. Other bar code formats may be used to scan product information such as Code 39, Code 128, Interleave 2 of 5, and PDF 417, for example.

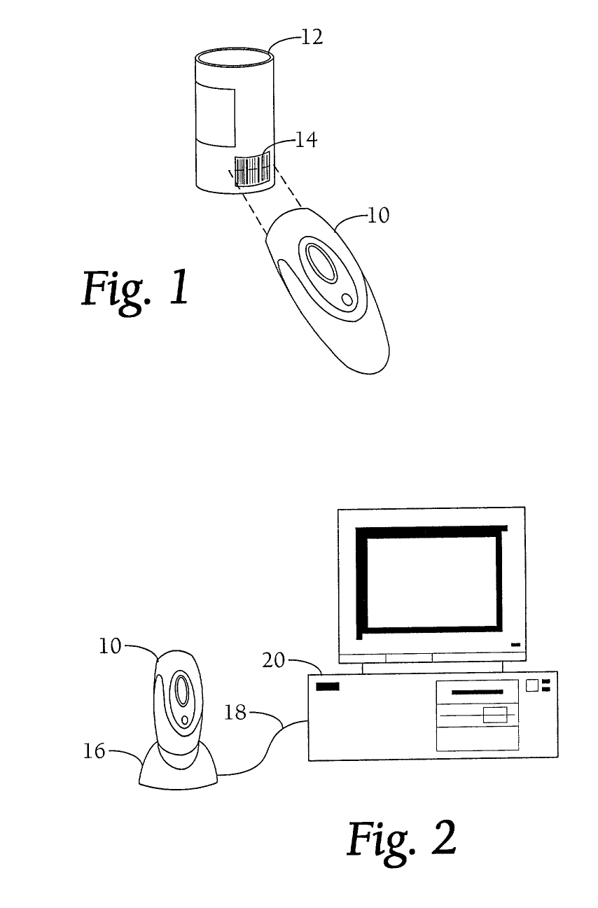

A basic bar code scanner 10, such as a CS 2000 consumer memory scanner from Symbol Technologies, consists of a scanner, and a decoder. The scanner's function is to scan the bar code symbol 14 and the bar code symbology. When scanner 10 is placed in interface cradle 16, the decoded data may be transmitted over serial line 18 to Internet access device 20 in a traditional data format. See FIG. 2. The consumer's Internet access device (IAD) 20 may be a personal desktop computer with Internet access, a laptop computer with Internet access, a personal computer such as a Palm Pilot with Internet access, web or Internet appliances such as Web TV or smart appliance hardware, e-mail Internet access appliances, or a cellular telephone with Internet access capabilities, to name a few.

The scanner 10 may be a bar code or text retrieval device that communicates with the consumer's IAD 20. Such scanning devices 10 may include portable laser scanners with storage to hold the scanned information to be transferred to the IAD 20 over a serial port or USB type port. The portable scanner may also transmit the information directly to the IAD 20 using an antenna or other transmission system. Fixed laser scanners connected directly to a serial port, USB or keyboard port of IAD 20 would not require internal storage capacity. CCD or text readers of fixed or portable types could also be utilized to scan product information and transfer this information to IAD 20.

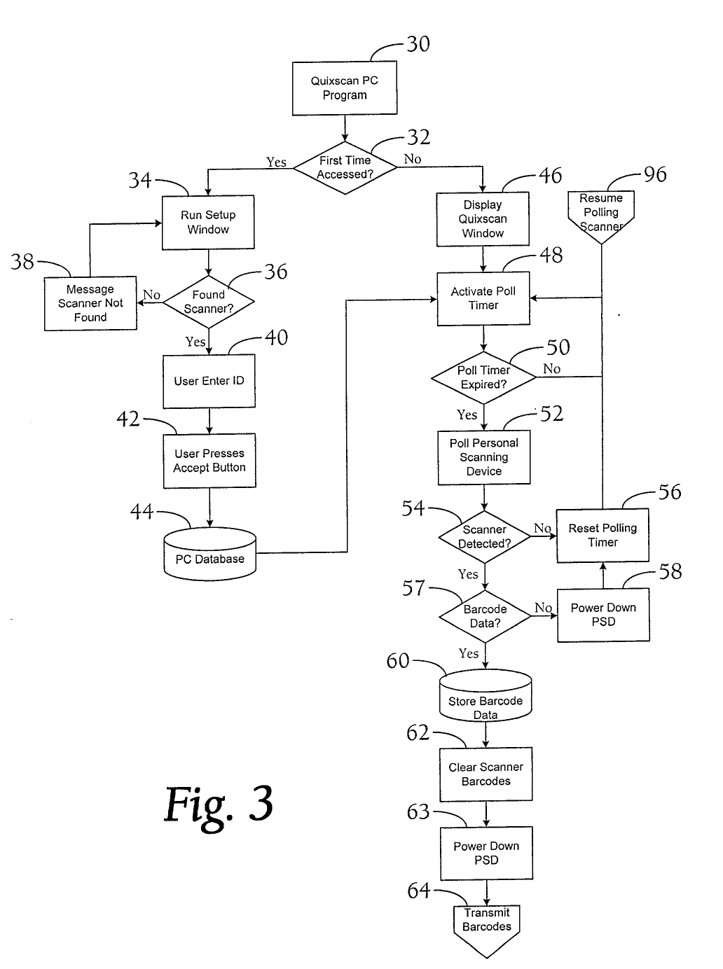

Referring to FIG. 3, Quixscan PC program 30 is loaded on PC 20 in a conventional manner. Once installed, Quixscan program 30 runs in the background and periodically polls cradle 16 to determine if scanner 10 is in place. Upon setup, if this is the first time the program is accessed 32, a setup window 34 is displayed. The software checks to see if the scanner 10 is placed in cradle 16. If the scanner is not found 36, an error message is displayed 38 and processing returns to setup window 34. If the scanner is found 36 the user is asked to enter an ID 40 and a license agreement is displayed 42. Upon acceptance of the terms of the license, the user's information and ID is stored in a database 44 located on PC 20.

If this is not the first time the software is accessed 32, the Quixscan window is displayed 46. Next, the poll timer is activated 48 which is periodically checked 50 to determine if the poll timer has expired. If poll timer has expired 50, personal scanning device 10 is polled 52. If scanner 10 is not detected 54 poll timer is reset 56 and processing returns to activate poll timer 48.

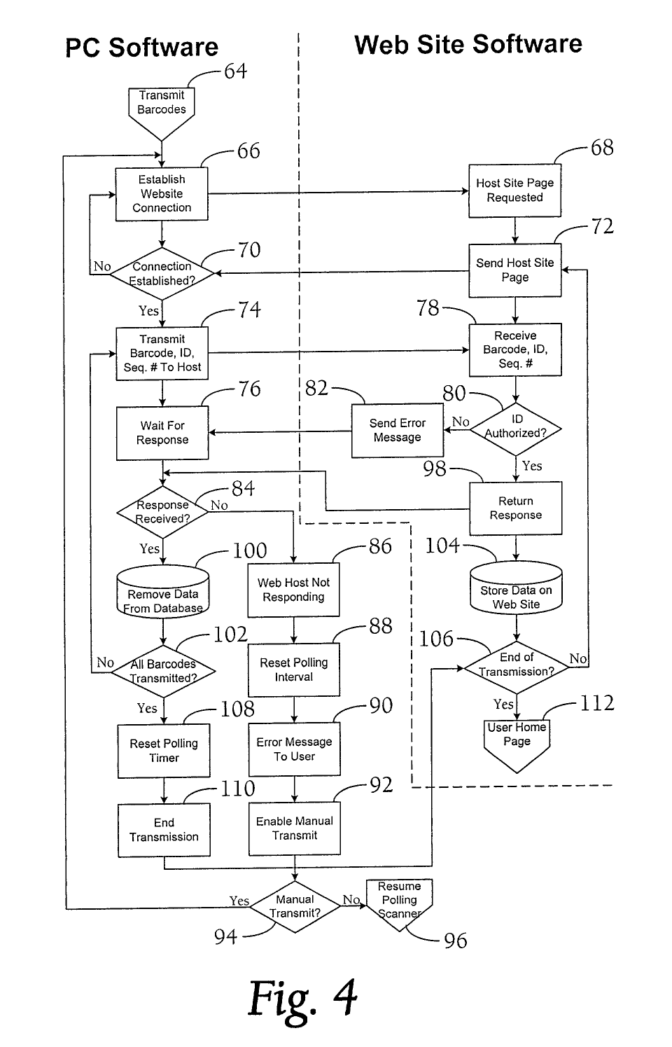

If the scanner is detected 54, the software determines if there is bar code data 57 in the scanner 10. If no bar code data is present 57, the scanner 10 is powered down 58 polling timer is reset 56 and processing returns to activate poll timer 48. If bar code data is present 57, the bar code data in scanner 10 is transferred to PC 20 and stored in database 60. Next, scanner bar codes are cleared 62, and the personal scanning device is powered down 63. From FIG. 3, the process of transmitting the bar code 64 continues in FIG. 4.

FIG. 4 illustrates the process of transmitting the bar codes from the PC to a web site or other computer system on an electronic network. From transmit bar code 64 the software attempts to establish the web site connection 66 using conventional methods such as a PC modem. Once the PC is connected to the Internet, the PC transmits the URL to request the host site page 68. If the web site is not connected or the connection is not established 70, the software again attempts to establish the web site connection 66. The software may attempt to establish the web site connection 66 several times before eventually displaying an error message to the user.

If the web site computer is active and receives the host site page request 68, the web site server will send the host site page 72 along with an acknowledgement to the PC for display. If the connection is established 70 the PC transmits the bar code, the customer ID and the sequence number to host 74 to the web site and waits for a response from the web site 76. When the web site receives this information 78, the ID is verified 80. If the ID is not authorized 80 the web site sends an error message 82 to the PC.

If a response is not received 84 because either the web host was not responding 86 or the web host sent an error message 82, the polling interval is reset 88. An error message is sent to the user 90 and the manual transmit is enabled 92. If manual transmit is selected 94, the process starts over again with establishing the web site connection 66. If manual transmit 94 is not selected, polling of scanner 10 is resumed 96 and the process continues at activate poll time 48 shown in FIG. 3.

If the ID is authorized 80, an acknowledge is returned 98 to the PC. After receiving the response 84, the bar code is removed from the PC database 100 and the software checks to determine if all bar codes have been transmitted 102. If all bar codes have not been transmitted 102, processing continues at transmit bar code ID and sequence number to the host 74. On the web site server, the data is stored on the web site 104. The web site software then checks to determine if an end of transmission has been received 106. If the end of transmission has not been received then processing continues at received bar code ID and sequence number 78. After all bar codes have been transmitted 102 the polling timer is reset 108 and an end of transmission message 110 is sent to the web site. When the end of transmission 106 is received, the user's home page is automatically displayed 112.

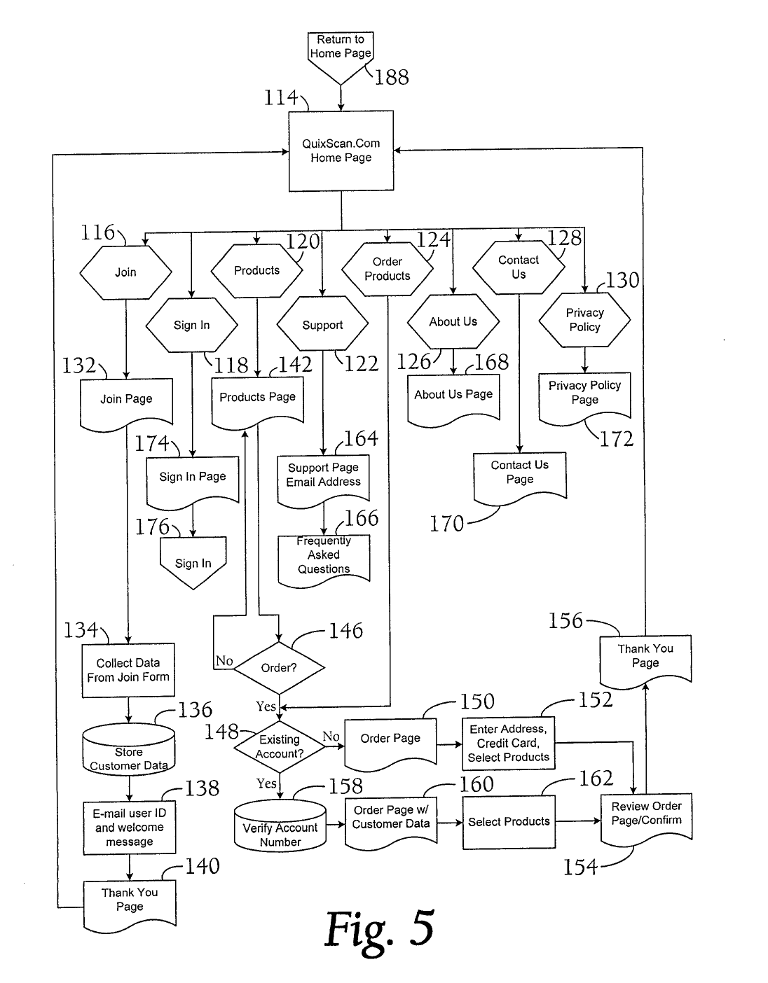

Referring to FIG. 5, a user may access the Quixscan home page by entering the Quixscan URL directly into the browser software. The Quixscan.com home page 114 is displayed which includes navigation links such as Join 116, Sign In 118, Products 120, Support 122, Order Products 124, About Us 126, Contact Us 128 and Privacy Policy 130.

If Join 116 is selected, Join Page 132 is displayed which includes fields into which a user may enter data such as name, address, credit card number and password for the user to become a member. Data is collected from the join form 134 and stored on the web site 136. The user's ID and a welcome message is automatically e-mailed 138 to the user and a Thank You Page 140 is displayed which provides a link back to the Quixscan home page 114.

If the user Selects Products 120 the Products Page 142 is displayed. From the Products Page 142 the user may select order 146 if the user decides to order one of the products shown on the Product Page 142. The software checks to see if this is an existing account 148. If the user has not joined and is thus not a member, an existing member account 148 is not found and order page 150 is displayed where the user enters his or her name, address, credit card and selects products 152. The order review page and confirmation page 154 is then displayed for the user to verify all information in block 152. If user accepts this information and orders the products, the Thank You Page 156 is displayed and a link is provided back to the Quixscan home page 114.

If the user has set up an account and the software verifies that the user has an existing account 148, the account number is verified 158 and the order page 160 is displayed with the customer data filled out. The customer may then select products 162 and review the order page and confirmation page 154. If the user continues to order the product selected, Thank You Page 156 is displayed and the user is provided a link back to home page 114.

If the user Selects Support 122, Support Page E-mail Address 164 is displayed with a link to Frequently Asked Questions Page 166.

If the user wishes to Order Products 124 directly from home page 114, processing continues to block 148. To find out information about the Quixscan company, the user may select About Us 126 to display the About Us Page 168. If the user wishes to contact the company the user may select Contact Us 128 and the Contact Us Page is displayed. Similarly, the user may wish to inquire about the privacy policy by selecting Privacy Policy 130 to display the Privacy Policy Page 172.

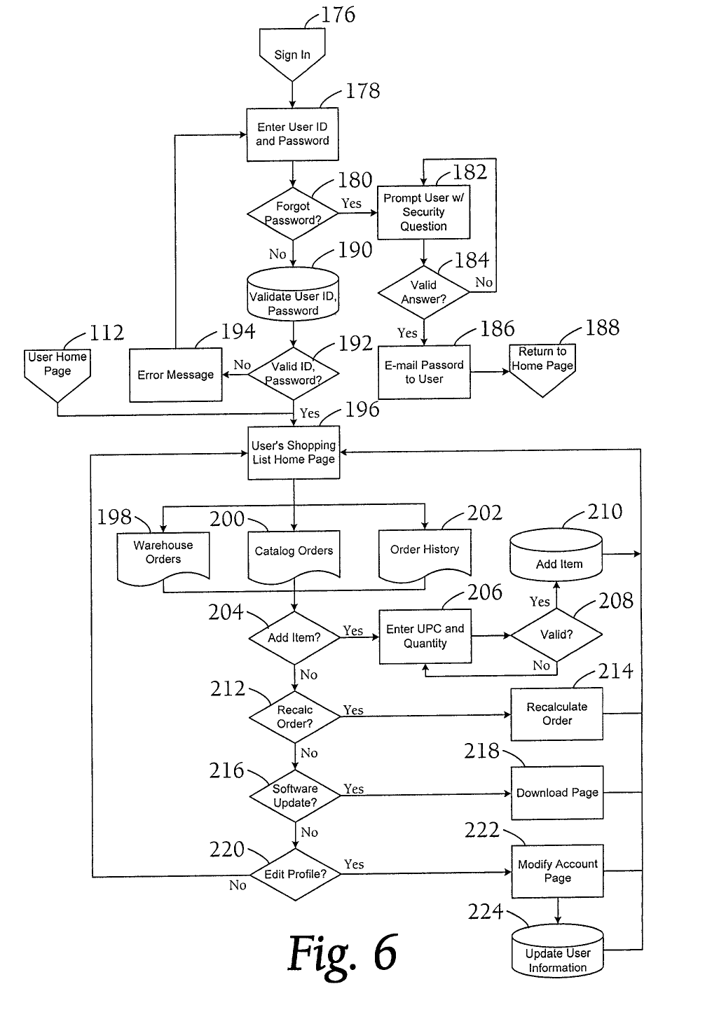

If the user has already set up an account, the user may select Sign In 118 to display the Sign In Page 174 and processing continues from the sign in block 176 to FIG. 6.

Referring to FIG. 6, the user may enter his or her ID and password 178. If the user has forgotten his or her password 180 the user is prompted with a security questions 182. If the user replies with a valid answer 184 the user's password is e-mailed to the user 186 and the Quixscan home page is displayed 188. If the user does not answer the security questions 182 with a valid answer 184 the security question is redisplayed 182. The user may be given several opportunities to enter a valid answer 184 before the user is disconnected. If the user enters an ID and password 178 the system validates the user ID and password 190 by comparing the entered data with data stored on the web site when the user set up his or her account. If the ID or the password is not valid 192, an error message 194 is displayed and the user is prompted to enter his or her ID and password 178 again. If a valid ID and password have been entered 192 the user's personal shopping list home page 196 is displayed. The user's shopping list home page 196 may include links to warehouse orders 198, catalog orders 200 and user's order history 202.

If the user wishes to add an item 204 the user may enter a UPC code and quantity 206 which is validated 208. If the UPC is not a valid code, the user is given an opportunity to enter a valid UPC code and quantity 206. If the data entered is valid 208, the item is added to the user's database 210 and the user's personal shopping list home page is displayed 196.

If the user does not wish to add an item 204, he or she may decide to recalculate the order total 212. Upon selection, the order is recalculated 214 and the user's shopping list home page 196 is displayed with the updated totals. The user may also wish to update the Quixscan software 216. Upon selection, a download page 218 is displayed where the user may download the PC Quixscan software or order a scanner.

The user may also edit his or her account profile 220, which upon selection, displays the modify account page 222. The user may decide to update his or her information 224 and return to the user's personal shopping home page 196 or retain the current information and go to the home page 196.

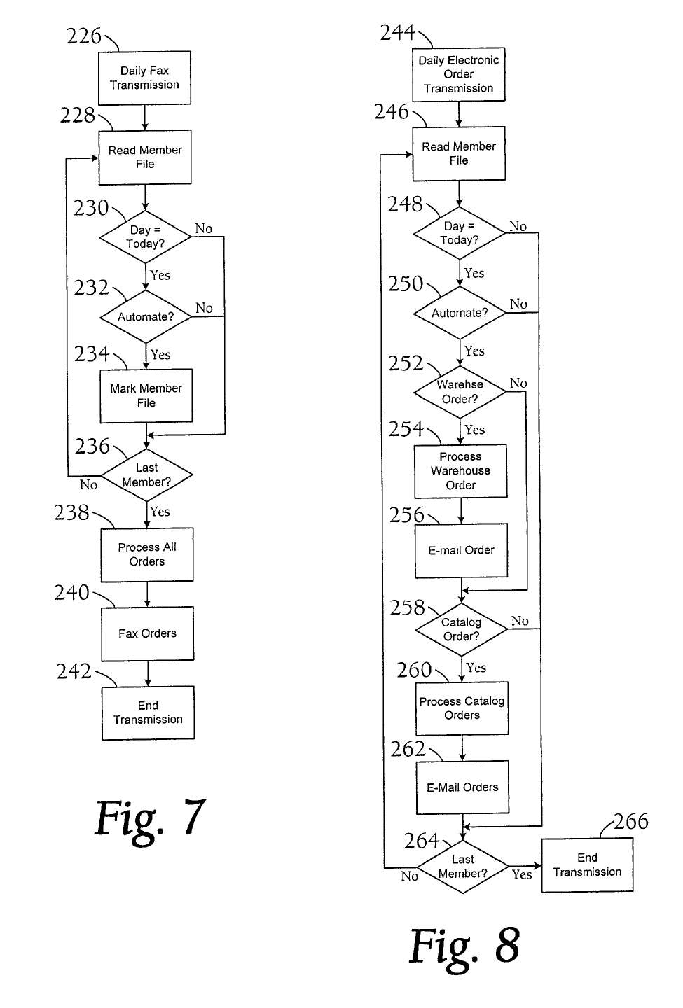

Referring to FIG. 7, the daily fax transmission process 226 runs in the background on the web site server to process customer orders and fax them to the appropriate retailer, distributor or manufacturer. Periodically, the daily fax transmission process 226 runs and a member file is read 228. If the order day equals today 230 processing continues to determine if the user has selected automated ordering 232. If the user has set automatic ordering, the user's file is marked for subsequent processing. Processing checks to determine if there are other member files 236. If this is not the last member 236, processing returns to reading the next member file 228 and repeats this loop. For any member file, if the order date is not today 230 or they are not set to automate 232, the member file is not marked for subsequent processing. After the last member file has been read 236 all orders are processed 238. Next, the orders are faxed 240 to the appropriate retailers, distributors or manufacturers and the process ends 242.

Referring to FIG. 8, the daily electronic order transmission process 244 is shown for those distributors, manufacturers or retailers which are set up to receive electronic orders. Daily electronic order transmission process 244 may run periodically or by user request. The first member file is read 246. If the day equals today 248 and the user has selected automation 250, the process determines if this is a warehouse order 252. If it is a warehouse order 252 the warehouse order is processed 254 and the order e-mailed 256 to the warehouse. Processing then continues on to determine if the user has also entered any catalog orders 258. If the user doesn't have any warehouse orders 252, warehouse processing 254 and e-mail orders 256 are bypassed and processing continues with determination of whether this is a catalog order 258. If this is a catalog order 258, the catalog orders are processed 260 and the orders emailed 262 to the retailer or the distributor. If the user had no catalog orders 258 processing bypasses the process catalog orders 260 and e-mail orders 262 processes. Next, the process determines if this was the last member. If it was not the last member 264, the next member file is read 246 and the process repeats. If this was the last member 264 then the process ends 266.

A member uses a PSD to collect catalog numbers, SKU numbers or web site addresses. The PC software is used to process this information and send it to a web site via the Internet using an Internet access device. The web site stores the processed information in a personalized and secured site based on a profile set up for the member or client. Information and software is used to order products or services or information on the Internet or by any other means to send orders or requests to retailers or wholesalers or distributors to purchase products or services or access web sites. This process may use a single web site or multiple web sites seamlessly linked together to act as a clearing house for orders or information being processed by the members or clients on their personalized site. The orders are sent to designated or non-designated retailers or wholesalers or distributors transact the purchases or retrieve information.

Customers may purchase a kit containing the following item or items and services. Due to technology improvements items and services may be replaced with improved items and services. This list is included as an example of options that may be provided but is not limited thereto.

a. A membership or account, or right to use web site to be known as member or client.

b. Personalized and secure access to customer's shopping list or list of items or services to propose to purchase.

c. A web tool or web tools; bar code scanner or bar code reader or text reader or any combination thereof.

d. The PC software reads and downloads any or all items that have been scanned or read into the web tool. The software processes information from the download and formats this information to be sent to the web site on or over the Internet using the customer's Internet access device to access the Internet and send information to the web site designated by the software.

e. Access to all software updates or patches.

f. Notification of all web sites enhancements available.

g. Notification of all new web tools available.

The web site may receive the member's list of purposed purchases or information locator request in a file secured for that member's activity only. Member or client may be required to fill out a member or client profile to be used for the processing of orders.

a. Name and address.

b. Ship to address if applicable.

c. Credit card information, optional.

d. Order automation, optional.

e. Retailers, wholesalers, or distributors to be used if specific are required.

f. Order process specifications, which may depend on retailers, wholesales or distributors being used.

The web site may process all information sent to the web site by the member or client. By comparing to pricing and availability data provided from retailers, wholesales or distributors or sending member or client to information site requested. This information may be placed in the members or clients secured and personalized listing for manipulation or approval or confirmation by client or member based on member or client profile setup.

The web site may process all approved or automated orders based on client or member profile and retailers of wholesalers or distributors requirements. This information may be turned into orders and sent to retailers or wholesalers or distributors, again based on client or member profile. Orders may be sent electronically and encrytpted for security by fax or EDI or any other method electronic that can maintain an acceptable security level.

Orders may be processed by retailers or wholesalers or distributors and sent to members or clients based on their existing standards and practices. All orders, backorders, non-available items or stock out situations may be the responsibility of the retailers or wholesalers or distributors.

The Quixscan system will move the whole concept of e-commerce to h-commerce (home-commerce) for the everyday consumer over the Internet. It allows high tech activities to be done from low-tech access. From the time consuming process currently on the Internet, such as search engines and purchasing to a process that only requires the press of a button to get it done. The Quixscan system not only benefits the high and low tech consumer giving every one access to the Internet but also allows businesses more exposure for their products.

The Web site Standard Header contains the following: Home, Products, Contact Us and About Us. Standard Footer contains the following: Home, Products, About Us, Contact Us, Sign In, Join, Privacy and Support. Standard Header and Footer are found on every page of the site. From the Home page, quick links have been made to provide a fast mechanism for users to get to the most frequently visited locations on the site. These links include: The order a scanner kit and other products page, Click to Join section and the Sign In and view shopping list/order history section of the site.

Members may access the extranet portion of the web site by using one of two methods. The first method is the typical method using a http capable browser and pointing the browser to http://www.quixscan.com. From there, the sign in link allows a user id and password to be entered to gain access to the Members active shopping list and order history (FIG. 6).

The second method involves the PC client software sending the client IBO# or Quixscan assigned number via the PC application and the Members Internet connection to the Quixscan.com server. Upon successful transmission of any bar code data member identification the PC Client software can (optional setting) automatically connect to the Quixscan.com web site where the Member Shopping List Home Page is displayed (FIGS. 3 and 6).

The Member Shopping List Home Page allows members to add, delete and view their active shopping list. In addition, the member may elect to delete the entire order with the click of a button as well as change individual line item quantities.

Daily, all orders are processed according to the members' Day of Week for processing of Warehouse Orders. For all orders whose members' Day of Week matches, those order are formatted and faxed to Quixtar for processing and eventually shipment.

In addition, all members whose profile is set to automate Catalog orders and have entered a credit card number; those orders are processed daily in batch as well.

It is to be understood that while certain forms of this invention have been illustrated and described, it is not limited thereto, except in so far as such limitations are included in the following claims.

Having thus described the invention, what is claimed as new and desired to be secured by Letters Patent is:

1. A method of obtaining an item in an online environment, comprising the steps of:
scanning at least one indicia indicative of an item with a scanning device,
transferring said scanned indicia to an Internet access device,
storing said scanning indicia on said Internet access device,
connecting said Internet access device to an Internet service provider and linking to a predetermined Web site having information associated with at least one available item and at least one vendor associated with said available item,
transferring said scanned indicia to said Web site,
comparing said scanned indicia with said available item,
if said scanned indicia matches said available item then performing the following step:
a. placing an order for said available item from said associated vendor, and disconnecting said Internet access device from said Internet service provider.

2. The method as claimed in claim 1 wherein said scanning step includes storing said scanned indicia in said scanning device.

3. The method as claimed in claim 2 further comprising polling said scanning device and initiating said transferring said scanned indicia to said Internet access device step if at least one scanned indicia is stored in said scanning device.

4. The method as claimed in claim 2 wherein said scanning step includes scanning a plurality of indicia and storing each of said plurality of indicia in said scanning device.

5. The method as claimed in claim 3 wherein said transferring said scanned indicia to said Internet access device step includes deleting each of said scanned indicia in said scanning device storage upon successful transfer to said Internet access device.

6. The method as claimed in claim 1 wherein said transferring said scanned indicia to said Internet access device step is automatically initiated in response to storing said scanned indicia in said scanning device.

7. The method as claimed in claim 1 wherein said connecting step is automatically initiated upon successful transfer of said scanned indicia from said scanning device to said Internet access device.

8. The method as claimed in claim 1 further comprising presenting an order screen to the user on said Internet access device upon transfer of said scanned indicia to said Web site, and prompting said user to select manual or automatic ordering.

9. The method as claimed in claim 8 further comprising automatically initiating said ordering step if automatic ordering is selected.

10. The method as claimed in claim 8 wherein said available item is associated with at least two vendors and wherein said order screen presents said user with a choice of among said vendors from which to order said available item.

11. The method as claimed in claim 1 wherein said scanned indicia is a barcode.

12. The method as claimed in claim 1 wherein said scanning device is a text scanner.

13. The method as claimed in claim 1 wherein said order is placed electronically.

14. The method as claimed in claim 1 wherein said order is placed by facsimile.

15. The method as claimed in claim 1 wherein said transferring said scanned indicia to said Web site step further includes transferring data for identifying the user of said Internet access device to said Web site.

16. The method as claimed in claim 15 further comprising billing said identified user for placing said order for said available item.

17. A product scanning and ordering system comprising:
scanning means for collecting and storing product information indicative of a product,
Internet access means having an electronic interface to said scanning means for receiving said scanned information and transmitting said information on the Internet,
a web site for receiving said scanned information from said Internet access means, and
means responsive to said transferred information for ordering said product corresponding to said product information.

18. The system as claimed in claim 17 further comprising means for identifying a user of said Internet access device by said Web site.

19. The system as claimed in claim 18 further comprising means for billing said user for said product ordered.
